(19) United States
(12) Patent Application Publication
(10) Pub. No.: US 2014/0172688 A1
(43) Pub. Date: Jun. 19, 2014

(54) PUBLIC TRANSACTION ACCOUNT SYSTEM AND METHOD

(71) Applicant: American Express Travel Related Services Company, Inc., (US)

(72) Inventors: Carlos Korten, Brooklyn, NY (US); Yue Xi, Middle Island, NY (US)

(73) Assignee: American Express Travel Related Services Compnay, Inc., New York, NY (US)

(21) Appl. No.: 13/715,423

(22) Filed: Dec. 14, 2012

(51) Int. Cl. G06Q 20/38

(52) U.S. Cl. CPC G06Q 20/38
USPC 705/39

(57) ABSTRACT

In various embodiments, the systems, methods and computer program products (collectively “systems”) are configured to administer and facilitate a public transaction program. The systems may issue public transaction accounts, identify public transactions and communicate those transactions or indicators of those transactions to a digital channel. The systems may be configured to allow users to define preferences that cause the systems to select particular transactions as public transactions. As such, the systems provide users and merchants with the ability to promote merchants and/or items through digital channels with transaction data.

### FIELD OF DISCLOSURE

The present disclosure generally relates to transaction management. More specifically, the disclosure relates to public notifications of transactions associated with a public transaction account.

### BACKGROUND

Transaction information has typically been considered private. However, with the rise in popularity of digital channels (e.g., social media) and the promotional potential of digital channels, there is a need to provide public access to certain types of transaction information for promotional or social purposes. As such, there is a need for a system to associate transaction information with digital channels.

### SUMMARY OF THE DISCLOSURE

In various embodiments, the systems, methods, and computer program products (collectively “systems”) described herein are generally configured to provide publicly accessible notifications of transactions associated with a public transaction account. The system may be configured to determine that a transaction account is a public transaction account. The public transaction account may be associated with at least some transactions that are public transactions. The system may evaluate transaction information (e.g., merchant information and/or item information) associated with the transactions based on preferences associated with the transaction account, if the transaction account is a public transaction account. The system may also generate instructions and/or a notification that include merchant and/or item information for a transaction based on the transaction information, and in response to the transaction account being a public transaction account. The instructions and/or notifications may be transmitted to a digital channel for display through the digital channel.

In various embodiments, the system may request and/or receive comments from a user in response to the transaction account being a public transaction account and the transaction information satisfying the preferences. Preferences may be defined by a user. The preferences may comprise one or more of item type selections, merchant type selections, and transaction selections. The system may be configured to determine a location and corresponding location information for the transaction (e.g., a merchant location). This location and/or the corresponding location information may be associated with the instructions and/or notification.

### BRIEF DESCRIPTION OF THE DRAWINGS

The features and advantages of the present disclosure will become more apparent from the detailed description set forth below when taken in conjunction with the drawings.

FIG. 1 illustrates a system for administering a public transaction program, in accordance with various embodiments.

FIG. 2 illustrates a process for identifying a public transaction associated with a public transaction account, in accordance with various embodiments.

FIGS. 3A and 3B illustrate public transactions displayed in a digital channel.

### DETAILED DESCRIPTION

In various e-embodiments, the systems described herein are generally configured to issue public transaction accounts, identify transactions that are public and/or provide notifications of transactions through digital channels. The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Any communication, transmission, channel and/or digital channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTube, AppleTV, Pandora, xBox, Sony Playstation), a uniform resource locator (“URL”), a document (e.g., a Microsoft Word document, a Microsoft Excel document, an Adobe.pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

Phrases and terms similar to “transaction account” may include any account that may be used to facilitate a financial transaction. As used herein a public transaction account may be a transaction account that is issued by an account issuer and is associated with a digital channel. Moreover, one or more of the transactions facilitated by the public transaction account may be identified or selected by a system. Notifications of the selected transactions may be posted to one or more digital channels associated with the public transaction account.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

With the rise in popularity of social media and digital marketplace promotions of merchants and items shifting, spending behaviors are becoming increasingly more public. Moreover, there is a general tendency to share personal information through digital channels with others associated with a digital channel (e.g., social media acquaintances). As a result, the public transaction account systems described herein provide users with the ability to share transaction information through digital channels. For example, celebrities may obtain a public transaction account to promote merchants and/or items. Social media users may obtain public transaction accounts to create a digital representation of their transactions that can be shared with others virtually. Moreover, the non-traditional promotions allow users to be rewarded by merchants for making their transactions publicly available. This allows the merchant to benefit from the promotion of the merchant's item and the user to benefit from the reward provided by the merchant. As a result, the public transaction account systems provide and administer a public transaction account program that facilitates sharing transactions through digital channels.

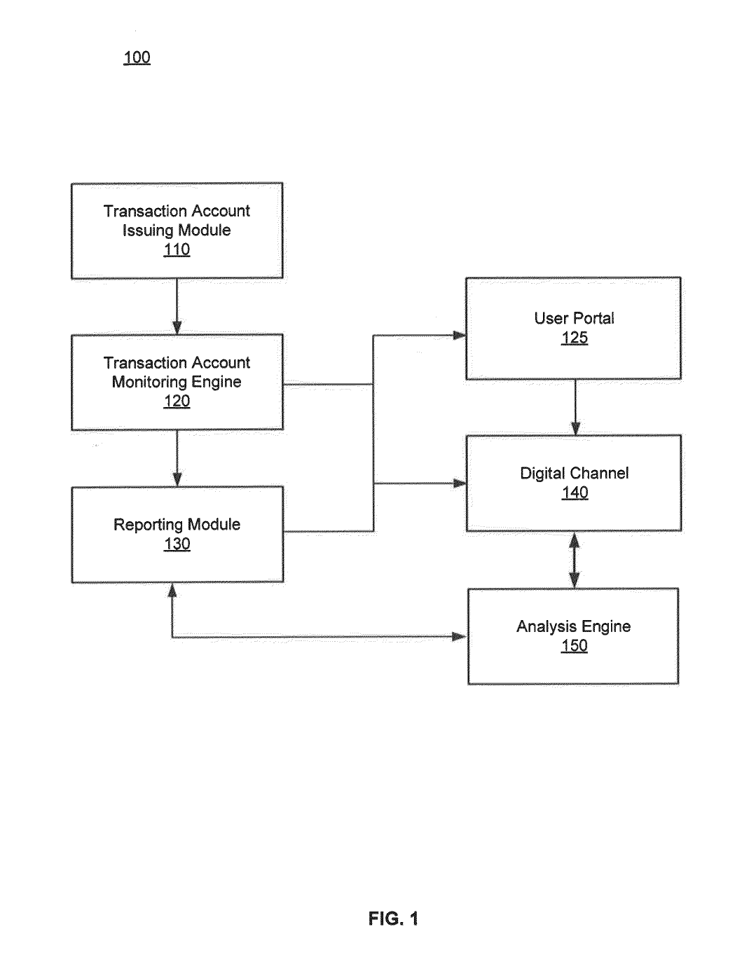

In various embodiments, and with reference to FIG. 1, system 100 may be any suitable hardware or hardware-software system configured to administer a public transaction account system 100 (“system 100”). System 100 may be capable of issuing public transaction accounts, processing transactions associated with the accounts, identifying transactions that may be public transactions, and transmitting transactions information, instructions and/or notifications to digital channels. System 100 may comprise one or more of a transaction account issuing module 110, a transaction account monitoring engine 120, a user portal 125, a reporting module 130, a digital channel 140, and an analysis engine 150.

Transaction account issuing module 110 may be any suitable system configured to issue public transaction accounts. Transaction account issuing module 110 may be operated by a payment processor, transaction account issuer, or third party. Transaction account issuing module 110 may be capable of accessing credit reports or credit histories, accessing credit worthiness, and/or extending lines of credit to users, who wish to have at least some of their transactions posted in one or more digital channels that are accessible to the public. Transaction account issuing module 110 may also be capable of issuing a public transaction account for any other suitable financial account. For example, transaction account issuing module 110 may issue a public transaction account associated with a stored value account (e.g., a prepaid transaction account) or a bank account (e.g., a checking account and/or a savings account). In this way, transaction account issuing module 110 may also issue public transaction accounts without determining the credit worthiness of a user or owner of the public transaction account.

Transaction account monitoring engine 120 may be coupled to or be in electronic communication with transaction account issuing module and/or other components of system 100. Transaction account monitoring engine 120 may be capable of receiving, processing, analyzing, and/or evaluating transactions associated with a public transaction account. Transaction account monitoring engine 120 may be further configured with a user interface accessible through a user portal 125 (e.g., a web client or other suitable user interface). Through user portal 125, a user may be capable of administering preferences and/or selections associated with a public transaction account. For example, a user may be able to select preferences that define how transaction account monitoring engine 120 evaluates, processes, and/or selects transactions that will be posted in digital channel 140. More specifically, the user may provide preferences that dictate what types of transaction are public transactions and what types of transaction are not public transactions.

Transaction account monitoring engine 120 may be capable of processing the transaction information to identify characteristics and/or attributes of the transaction. For example, transaction account monitoring engine 120 may be configured to determine particular merchant information, item information, and an associated merchant location for the public transaction. This merchant information (e.g., a merchant name), the location information (e.g., a particular merchant location), and transaction information (e.g., a transaction amount, a transaction date, and/or the like) may be associated with the instructions and/or notification for further evaluation by reporting module 130 and/or digital channel 140.

Reporting module 130 may be coupled to or be in electronic communication with transaction account monitoring engine 120 and/or other components of system 100. Reporting module 130 may be capable of receiving and processing transactions or transaction information associated with a public transaction account. The transactions and/or associated transaction information may satisfy the preferences associated with the public transaction account such that those transactions are public transactions. Reporting module 130 may be capable of generating instructions and/or a notification associated with the transaction and/or transaction information. These instructions and/or notifications may be communicated to one or more components of system 100 including, for example, digital channel 140.

Digital channel 140 may be coupled to or in electronic communication with reporting module 130 and/or any other component of system 100. In various embodiments, digital channel 140 may be capable of receiving, processing generating, creating, and/or evaluating instructions and/or notifications associated with public transactions. Moreover, digital channel 140 may comprise mapping and display functionality. For example, digital channel 140 may comprise a map and may be capable of associating notifications of public transactions on the map. The location on the map may correspond to a merchant location associated with the public transaction. Moreover, digital channel 140 may be capable of processing instructions from transaction account monitoring engine 120 and/or reporting module 130 to create public transaction notifications that are associated with specific merchant locations. This map and associated notifications may be publicly accessible through the channel. Moreover, the digital channel may be operated by at least one of a transaction account issuer, a payment processor, and/or a third party such as, for example, a social media channel provider.

Analysis engine 150 may be coupled to or in electronic communication with transaction account monitoring engine 120, reporting module 130, digital channel 140 and/or any other suitable system component. In various embodiments, analysis engine 150 may be capable of receiving, categorizing, organizing, processing and/or analyzing public transaction information. Analysis engine 150 may comprise various analytical and predicative engines. As such, analysis engine 150 may be capable analyzing public transaction information to predict behaviors, identify trends, evaluate product or service acceptance, and/or the like. Moreover, analysis engine 150 may be capable of receiving authorization information. In this way, analysis engine 150 may be capable of real-time (e.g., instant or nearly instant) predicative modeling (e.g., in the time between and authorization request from a merchant and the authorization from the transaction account issuer).

In various embodiments, digital channel 140 may be capable of making the data available to any suitable user in any suitable format. For example, digital channel 140 may be capable of consolidating data for use by a merchant or analysis engine 150. The public transaction data and/or analysis may be provided by one or more merchant. The data and/or analysis may be used to characterized or identify potential customer, consumer trends, spending behaviors, product acceptance, and/or the like. Moreover, the public transaction may be used by merchant as endorsements.

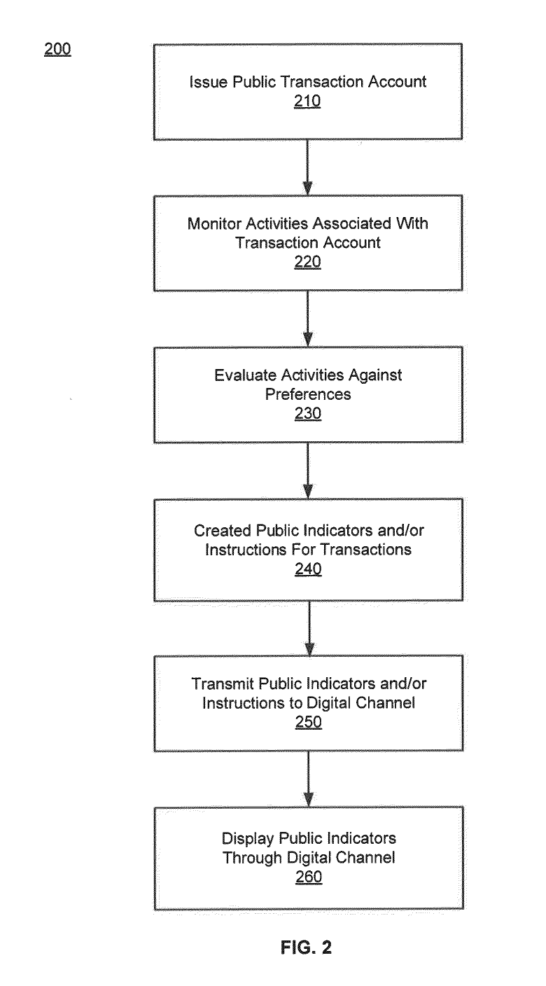

In various embodiments, and with reference to FIGS. 1 and 2, system 100 may be capable of performing a process 200 for managing a public transaction account. Transaction account issuing module 110 may be capable of issuing a public transaction account (Step 210). Transaction account issuing module 110 may be capable of issuing a card that is dedicated to one or more digital channels 140 or that can be associated with one or more digital channels 140 based on user selections or preferences. For example, transaction account issuing module 110 may be configured to identify and/or associate one or more digital channel with a transaction account based on information provided by a user or consumer who applies for the transaction account.

Transaction account issuing module 110 may further be capable of requesting, capturing and/or associating user preferences with the public transaction account. A user may be able to provide, identify, and/or associate (e.g., through transaction account issuing module 110) particular attributes, types, or parameters of a transaction that make the transaction a public transaction, which may be displayed through a digital channel. For example, a user may specify a transaction amount, merchant type, item type, date range, and/or any other suitable attribute. Transaction account issuing module 110 may also issue a transaction account where all transaction are public, regardless of the parameters of the transaction.

Moreover, system 100 may be capable of monitoring transaction information associated with a public transaction account through transaction account monitoring engine 120 (Step 220). The transaction account monitoring engine 120 may receive transaction information from a payment processor (e.g., a bank, transaction account issuer, and/or the like), merchant, and/or payment terminal. Transaction account monitoring engine 120 may further process the transaction information and may, optionally, evaluate the transaction against preferences defined by the user (Step 230). As noted herein, some public transaction accounts may not have preferences associated with transactions to determine whether a transaction is a public transaction.

In response to the transaction account monitoring engine 120 identifying a transaction as a public transaction, reporting module 130 may create a public indicator and/or instructions for displaying the public transaction (Step 240). For example, transaction account monitoring module 120, and/or reporting module 130 may parse the transaction data to identify attributes of the transaction that will be displayed in the digital channel. The attributes may be further modified (e.g., based on rules associated with the channels, preferences from the user, rules provided by system 100, and/or the like). Transaction account monitoring module 120 and/or reporting module 130 may further identify a specific merchant location for the transaction. For example, based on the transaction data, transaction account monitoring module 120 and/or reporting module 130 may determine the exact location of the merchant (e.g., a particular merchant location) where the transaction took place (e.g., for a merchant that has multiple locations). This determination may be based on any suitable transaction data such as, for example, a code identifying the merchant location provided with the transaction data, an input or comment from a user, and/or the like. The determined location may be associated with the notification and/or instructions or otherwise provided to the digital channel.

Reporting module 130 may be further configured to transmit the instructions and/or indicators to a digital channel for display in digital channel 140 (Step 250). The digital channel may evaluate, format, and/or process the notifications and/or instructions. Moreover, the digital channel may determine merchant locations on a map provided through digital channel 140 based on the location information provided by reporting engine 130. Digital channel 140 may associate notifications of public transactions with the merchant location and display public indicators through digital channel 140 (Step 260).

Reporting module 130 may further be capable of contextualizing or associated additional data (e.g., data beyond transaction data) with the public transaction. For example, reporting module 130 may be capable of associating a trend or fact about a merchant or user with the indicator of the public transaction. A user may also be capable of defining the indicator provided by reporting module 130. Moreover, that indicator may be customizable. For example, in the context of a broad cast channel (e.g., a social media channel such as, for example, Twitter), a user may define the indicator with some text and an indicator associated with a merchant (e.g., a merchant hashtag, such as, for example, #MERCHANT A), associated with the transaction. Reporting module 130 may be capable of parsing the transaction information and automatically associating the indicator associated with the merchant based on the transaction information. In this way, reporting module 130 may be capable of providing multiple unique public transaction notifications to a digital channel for multiple transactions, where each of the notification includes transaction information, the user defined indicator and the unique automatically identified indicator associated with the merchant.

In various embodiments, the indicator for a public transaction may be provided to a user for approval or manipulation prior to being provided to the digital channel. For example, a user may provide an input to a computing device (e.g., a smart phone, a computer, a tablet, and/or the like) to indicate whether the experience with the merchant, good, and/or service associated with the transaction was positive or negative. The user may have provided predefined indicator associated with a selection of a positive experience and a predefined indicator associated with a selection of a negative experience. In response to receiving the selection, system 100 may generate the appropriate indicator, include automatically generated information associated with the transaction and with the merchant, good, and/or service. In response to the generation of the indicator of the public transaction, the indicator may be provided to and/or posted to one or more digital channels 140.

In various embodiments, system 100 or a merchant may be capable of providing rewards to a user associated with the public transaction. As noted herein, the promotional value of a public transaction may benefit merchants. In order to incentivize a user to make public transactions, merchants may provide rewards for public transactions. The merchants may provide the rewards in any suitable fashion including, for example, to the transaction account through system 100. Generally, the merchant may provide experience type rewards, monetary rewards (e.g., credits, points, discounts, rebates, and/or the like), and virtual currency type rewards (e.g., virtual accomplishment indicators, virtual badges, status levels, and/or the like). For additional information on rewards programs, see U.S. patent application Ser. No. 13/587,486, Filed on Aug. 16, 2012, which is hereby incorporated by reference in its entirety for all purposes.

In various embodiments, digital channel 140 may comprise additional data about a user. For example, where digital channel 140 is a social media channel (e.g., Facebook, Foursquare, LinkedIn, and/or the like), user information from the digital channel may be captured by system 100 or any other suitable analytics or tailored marketing platform. The social data may be used to supplement data about a user to better understand the user's behaviors and/or interests. In this way, the data may be used to provide tailored marketing of offers, rewards, items and/or the like to the user based on the information in the channel. For additional information on tailored marketing, see U.S. patent application Ser. No. 13/439,768, filed on Apr. 4, 2012 and U.S. Patent Application No. 61/700,850, filed on Sep. 13, 2012, each of which is hereby incorporated by reference in its entirety for all purposes.

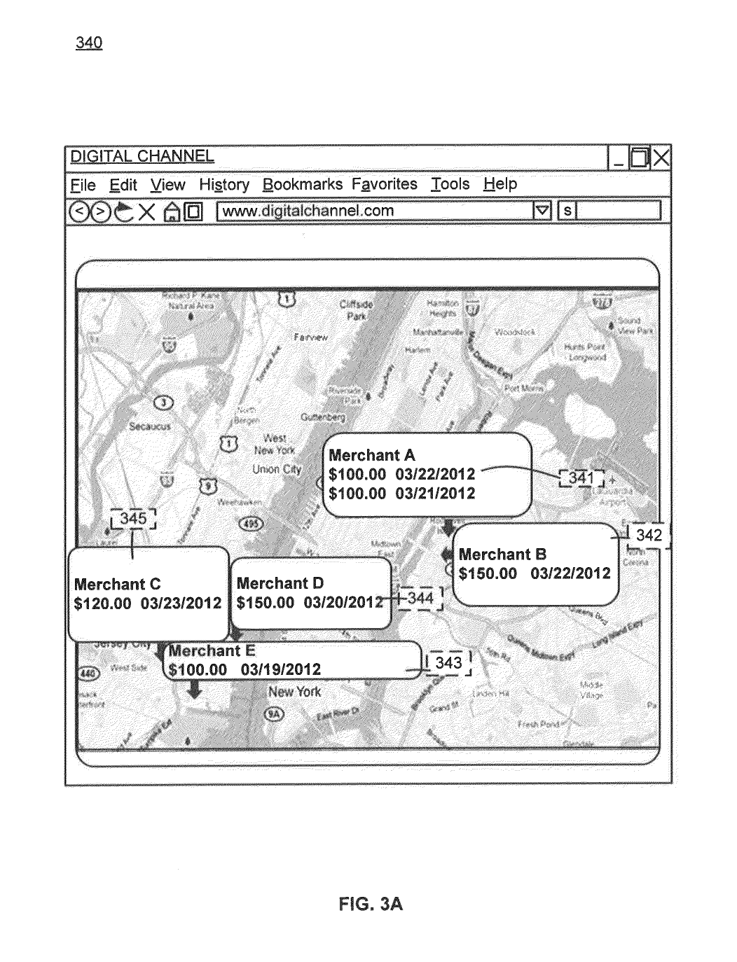

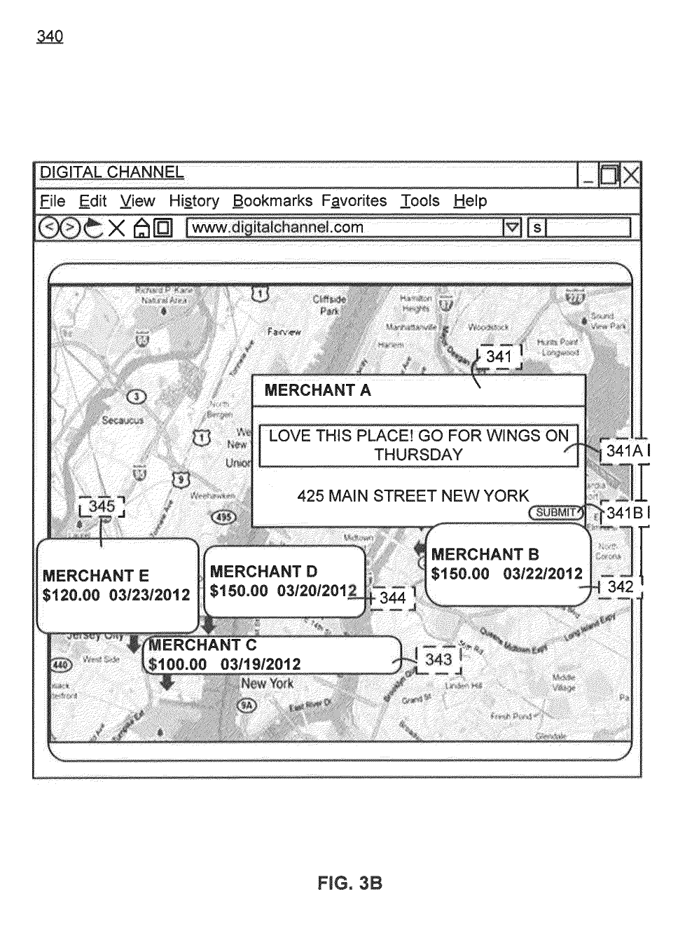

In various embodiments, and with reference to FIG. 3, digital channel 340 may be any suitably accessible digital channel. For example, the digital channel may be a social media channel, a digital channel provided by a merchant, a digital channel provided by an item manufacturer, a digital channel provided the a payment processor, and/or the like. As described herein, the digital channel may comprise a map. The map may be interactive and searchable by a user (e.g., a member of the general public, a user of the digital channel, a user associate with the transaction account (e.g., an account affiliate or a user associated with the account affiliate in the digital channel), and/or the like).

Digital channel 340 may be configured to display indicators of one or more transactions at merchant locations on the map. Digital channel 340 may be configured to display one or more indicators describing public transactions. For example, indicator 341 associated with merchant A, indicator 342 associated with merchant B, indicator 343 associated with merchant C, indicator 344 associated with merchant D, and/or indicator 345 associated with merchant E. In various embodiments, these indicators may comprise one or more transactions, a transaction amount, a merchant name, a transaction date, and/or the like. Further, the indicators may be selectable by a user.

A component of system 100 including digital channel 140/340 (and/or any other suitable component) may also be configured to request and/or receive comments from a user. As illustrated in FIG. 3B, comment 341A may be provided within an indicator (e.g., indicator 341) associated with a merchant (e.g., merchant A). The comment may be provided in the channel. For example, the user associated with the public transaction may select the indicator, include a comment (e.g., provide a comment in a text box) and submit the comment (e.g., submit button 341B). In response to submitting the comment, the indicator may be modified and/or updated to include the comment. The comment may be associated with a particular transaction or with the merchant. In this way, the comment may be a spend verified review or endorsement because the comment is associated with transaction information or is linked to a merchant where a transaction occurred. For additional information on spend verified reviews, please see U.S. Patent Application Ser. No. 61/701,688, filed on Sep. 16, 2012, which is herein incorporated by reference in its entirety for all purposes. The comment may also be provided to any other component of system 100 (e.g., transaction account monitoring engine 120, reporting module 130, and/or the like). The comment may be associated with the indicator or instructions generated by reporting module 130 and provided to the digital channel.

As such, the system described herein may facilitate the operation of a public transaction account program. Moreover, the systems may provide merchants, payment processors and/or users with the ability to promote merchants and/or items, receive rewards, and share transaction data with the public.

A “consumer profile” or “consumer profile data” may comprise any information or data about a consumer that describes an attribute associated with the consumer (e.g., a preference, an interest, demographic information, personally identifying information, and the like).

As used herein, “matches” or similar terms may include an exact match, partial match, suitably associated with, meeting certain criteria, satisfying certain rules and/or the like.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, and JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NISTs (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re NuijYen to fall outside the scope of patentable subject matter under 35 U.S.C. §101.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method executable by a processor of a computer based system programmed for administering a public transaction account program, the method comprising,
associating, by the processor, a transaction account with a publicly accessible digital channel, wherein the publicly accessible digital channel is configured to publicly display indications associated with transactions, wherein the transactions are associated with the transaction account;
evaluating, by the processor, transaction information from a first transaction and based on preferences associated with the transaction account, in response to the transaction account being a public transaction account;
requesting, by the processor, a selection to indicate nature of an experience associated with a transaction;
generating, by the processor, at least one of instructions and a notification for the first transaction, based on the selection and the evaluating, wherein the notification comprises an indicator associated with the selection and at least a portion of the transaction information; and
transmitting, by the processor, at least one of the instructions and the notification to a digital channel for display through the digital channel, wherein the digital channel is accessible by a public user who is not a user of the transaction account.

2. The method of claim 1, wherein the transaction information includes at least one of merchant information, item information, and a transaction amount.

3. The method of claim 2, wherein at least one of the instructions and the notification contain the merchant information and the item information.

4. The method of claim 1, further comprising associating, by the processor, a comment from a user with the at least one of the instructions and the notification.

5. The method of claim 4, further comprising requesting, by the processor, the comment from the user, in response to the transaction account being the public transaction account and the transaction information satisfying the preferences.

6. The method of claim 1, wherein the preferences are provided by a user.

7. The method of claim 1, wherein the preferences comprise at least one of item type selections, merchant type selections, and transaction selections.

8. The method of claim 1, further comprising issuing, by the processor, the transaction account as the public transaction account by a transaction account issuer.

9. The method of claim 1, wherein the digital channel is administered by at least one of a transaction account issuer and a third party.

10. The method of claim 1, wherein the digital channel is a social media channel.

11. The method of claim 1, further comprising:
determining, by the processor, a location associated with the first transaction;
associating, by the processor, the location information with at least one of the instructions and the notification.

12. The method of claim 11, wherein the digital channel is configured to display an indicator of the first transaction associated with the location.

13. The method of claim 12, wherein the indicator is based on at least one of the instructions and the notification.

14. The method of claim 12, wherein the indicator is displayed on a map through the digital channel.

15. The method of claim 12, wherein the indicator is selectable by a user in the digital channel.

16. The method of claim 12, wherein the indicator is publicly accessible through the digital channel.

17. The method of claim 1, wherein a user of the public transaction account is rewarded by a merchant based on the first transaction.

18. The method of claim 17, wherein the merchant confirms the first transaction by the user with the public transaction account.

19. A tangible, non-transitory computer readable medium having computer-executable instructions stored thereon that, if executed by a computer based system programmed for administering a public transaction account program, causes the computer based system to be capable of performing operations comprising:
associating, by the processor, a transaction account with a publicly accessible digital channel, wherein the publicly accessible digital channel is configured to publicly display indications associated with transactions, wherein the transactions are associated with the transaction account;
evaluating, by the computer based system, transaction information from a first transaction and based on preferences associated with the transaction account, in response to the transaction account being a public transaction account;
requesting, by the computer based system, a selection to indicate nature of an experience associated with a transaction;
generating, by the computer based system, at least one of instructions and a notification for the first transaction, based on the selection and the evaluating, wherein the notification comprises an indicator associated with the selection and at least a portion of the transaction information; and
transmitting, by the computer based system, at least one of the instructions and the notification to a digital channel for display through the digital channel, wherein the digital channel is accessible by a public user who is not a user of the transaction account.

20. A computer based system, comprising:
a processor programmed for administering a public transaction account program;
a tangible, non-transitory memory configured to communicate with the processor, the non-transitory memory having instructions stored thereon;
a transaction account monitoring engine configured to associate a transaction account with a digital channel, wherein the publicly accessible digital channel is configured to publicly display indications associated with transactions, wherein the transactions are associated with the transaction account;
the transaction account monitoring engine configured to evaluate transaction information from a first transaction and based on preferences associated with the transaction account, in response to the transaction account being a public transaction account;
the transaction account monitoring engine further configured to a selection to indicate nature of an experience associated with a transaction;
a reporting module configured to generate at least one of instructions and a notification for the first transaction, based on the selection and the evaluating, wherein the notification comprises an indicator associated with the selection and at least a portion of the transaction information; and
the reporting module configured to transmit at least one of the instructions and the notification to a digital channel for display through the digital channel, wherein the digital channel is accessible by a public user who is not a user of the transaction account.
